(19) United States
(12) Patent Application Publication
(10) Pub. No.: US 2026/0075442 A1
(43) Pub. Date: Mar. 12, 2026

(54) DATA TRANSMITTING METHOD AND DATA TRANSMITTING SYSTEM

(71) Applicant: REALTEK SEMICONDUCTOR CORPORATION, HSINCHU (TW)

(72) Inventors: ZHEN-TING HUANG, Hsinchu (TW); CHIA-YI CHANG, Hsinchu (TW); CHIH-YUAN HUANG, Hsinchu (TW); PEI-HUNG CHU, Hsinchu (TW); ER-ZIH WONG, Hsinchu (TW)

(21) Appl. No.: 19/319,965

(22) Filed: Sep. 5, 2025

(30) Foreign Application Priority Data
Sep. 10, 2024 (TW) 113134311

(51) Int. Cl. H04W 24/02

(52) U.S. Cl. CPC H04W 24/02

(57) ABSTRACT

A data transmitting method is disclosed herein. A processor reads at least command stored in a memory and executes the data transmitting method. The data transmitting method includes following steps: adjusting a delay time into a target time according to a standby signal; after waiting for the target time, determining whether there is at least one data packet to decide whether to transmit the at least one data packet; and executing a standby mode.

### BACKGROUND OF THE INVENTION

### 1. Field of the Invention

The present disclosure relates to a data transmitting method and a data transmitting system, especially to a data transmitting method and a data transmitting system that reduce a delay time for entering a standby mode.

### 2. Description of Related Art

When consumers temporarily stop using electronic devices, they can activate the standby mode (Modern Standby) of the electronic device to save power. When the electronic device is about to enter the standby mode, the electronic device must wait for a delay time to transmit the data packets that need to be transmitted.

From the perspective of consumer experience, when the electronic device is about to enter the standby mode, the aforementioned delay time should be as short as possible to allow the electronic device to enter the standby mode quickly. However, in the prior art, when consumers select the standby mode, they still have to wait for a long delay time, which severely affects the consumer experience.

### SUMMARY OF THE INVENTION

In some aspects, an object of the present disclosure is to, but not limited to, provides a data transmitting method and a data transmitting system that makes an improvement to the prior art.

An embodiment of a data transmitting method of the present disclosure, which is executed by a processor reading at least one command stored in a memory, includes following steps: adjusting a delay time to a target time according to a standby signal; after waiting for the target time, determining whether there is at least one data packet to decide whether to transmit the at least one data packet; and executing a standby mode.

An embodiment of a data transmitting system of the present disclosure includes a memory and a processor. The memory is configured to store at least one command. The processor is configured to read the at least one command to execute following steps: adjusting a delay time to a target time according to a standby signal; after waiting for the target time, determining whether there is at least one data packet to decide whether to transmit the at least one data packet; and executing a standby mode.

Technical features of some embodiments of the present disclosure make an improvement to the prior art. The data transmitting method and the data transmitting system of the present disclosure can adjust the delay time for entering the standby mode to the target time to significantly reduce the waiting time. As a result, after the consumer selects the standby mode, the data transmitting system can quickly enter the standby mode, thereby enhancing the consumer experience.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows an embodiment of a data transmitting system of the present disclosure.

FIG. 2 shows an embodiment of a flow diagram of a data transmitting method of the present disclosure.

FIG. 3 shows an embodiment of an operation diagram of a data transmitting system of the present disclosure.

FIG. 4 shows an embodiment of an operation diagram of a data transmitting system of the present disclosure.

### DETAILED DESCRIPTION OF THE PREFERRED EMBODIMENTS

To address the problem that the delay time for the electronic device to enter the standby mode is long, the present disclosure provides a data transmitting method and a data transmitting system, which will be explained in detail as shown below.

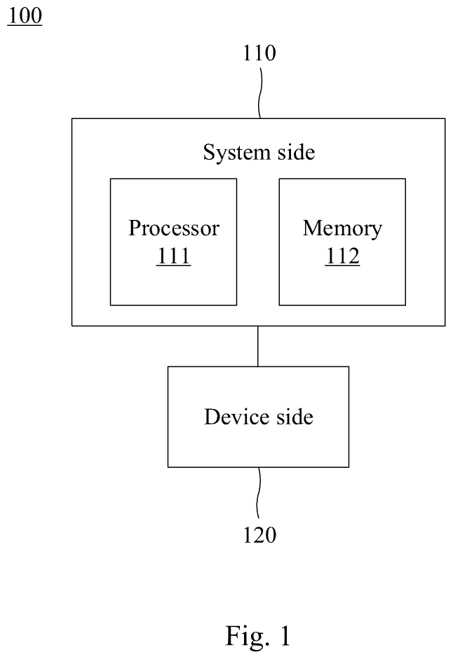

FIG. 1 shows an embodiment of a data transmitting system 100 of the present disclosure. As shown in the figure, the data transmitting system 100 includes a system side 110 and a device side 120. The system side 110 includes a processor 111 and a memory 112. The memory 112 is configured to store at least one command. The processor 111 is configured to read the at least one command to execute a data transmission. In some embodiments, the system side 110 can be a desktop computer, a notebook computer, or a tablet. The device side 120 can be a network interface controller (NIC), a Wi-Fi chip, or a Bluetooth chip.

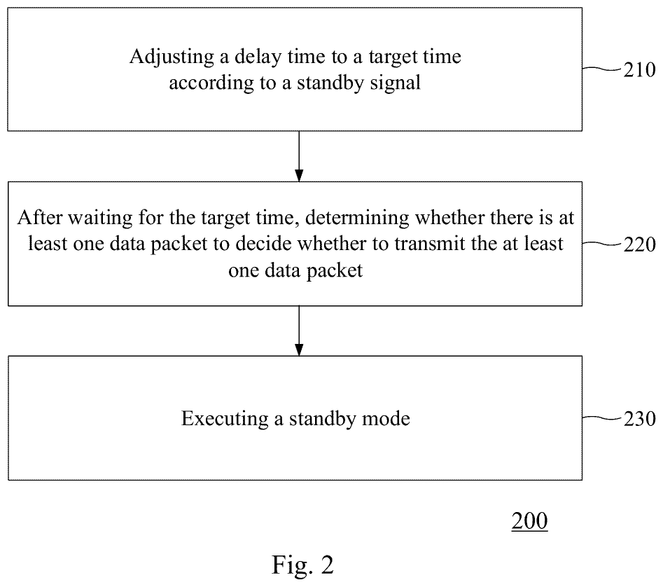

For facilitating the understanding of the operations of the data transmitting system 100, reference is made to FIG. 2. FIG. 2 shows an embodiment of a flow diagram of a data transmitting method 200 of the present disclosure.

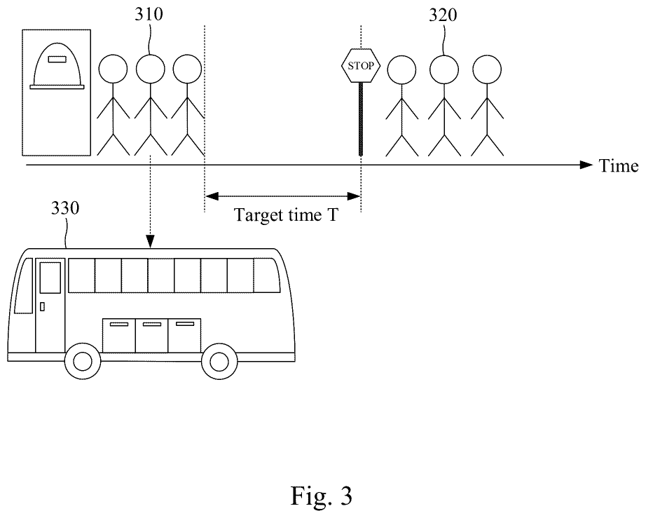

In step 210, adjusting a delay time to a target time according to a standby signal. In step 220, after waiting for the target time, determining whether there is at least one data packet to decide whether to transmit the at least one data packet. In step 230, executing a standby mode. For example, referring to FIG. 3, for facilitating the understanding, assume that passengers 310, 320 represent data packets, and bus 330 represents USB Request Block (URB). When the consumer temporarily stops using the data transmitting system 100, the consumer can activate the standby mode (Modern Standby). At this time, the system side 110 outputs a standby signal. When the device side 120 receives the standby signal, the device side 120 will adjust the delay time to the target time T according to the standby signal. For example, the target time ranges from 1 μs (microsecond) to 5 ms (millisecond). Subsequently, after waiting for the target time T, the processor 111 will determine whether there is a data packet to decide whether to transmit the data packet or not. For example, in FIG. 3, there is indeed a data packet 310, and the USB Request Block 330 will transmit the data packet. Conversely, if there is no data packet, then no transmission of data packet will occur. Consequently, the data transmitting system 100 can enter the standby mode to save power.

Since the data transmitting system 100 of the present disclosure can adjust the delay time for entering the standby mode to the target time, the waiting time is significantly reduced. As a result, after the consumer selects the standby mode, the data transmitting system 100 can quickly enter the standby mode, thereby enhancing the consumer experience. In addition, since the waiting time is reduced, the data transmitting system 100 with the standby mode will not timeout, which would reset the USB Request Block and lead to data packet loss.

In some embodiments, referring to step 210, the data transmitting system 100 of the present disclosure can decrease the delay time to the target time according to the standby signal. For example, typical delay time ranges from 20 milliseconds to 30 milliseconds, and such a long delay time would severely affect the consumer experience. The data transmitting system 100 of the present disclosure can decrease the aforementioned delay time to the target time, which can be 1 millisecond, making the target time significantly shorter than the delay time. In view of the above, the data transmitting system 100 of the present disclosure can greatly reduce the waiting time, thereby enhancing the consumer experience. However, the present disclosure is not limited to the aforementioned embodiment, as it is only used to illustratively explain one implementation of the present disclosure. In other embodiments, the target time can be 2 milliseconds, 3 milliseconds, 4 milliseconds, 5 milliseconds, or any other suitable duration, depending on actual requirements.

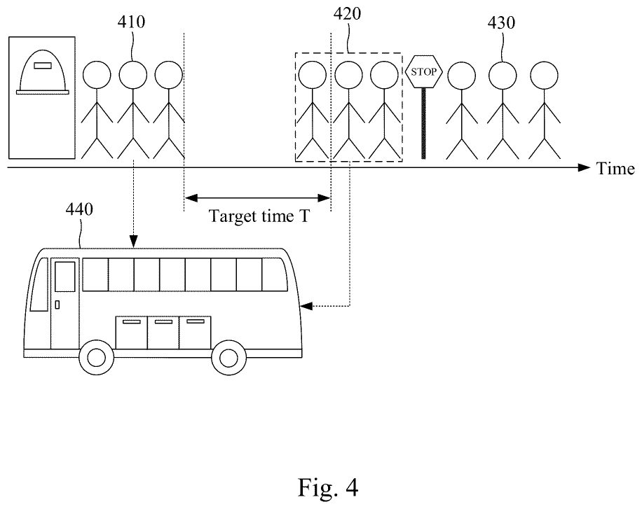

In some embodiments, please refer to step 220, after the data transmitting system 100 of the present disclosure waits for the target time, if there is at least one data packet, it determines whether a transmission of the at least one data packet is complete. If it is determined that the transmission of the at least one data packet is not complete, the data transmitting system 100 continues transmitting the at least one data packet. For example, reference is made to FIG. 4. For facilitating the understanding, assume that the passengers 410, 420, 430 represent data packets, and the bus 440 represents a USB Request Block. After the data transmitting system 100 of the present disclosure waits for the target time T, if there is a data packet 420, it determines whether a transmission of the data packet 420 is complete. As shown in FIG. 4, only a portion of data packet 420 is transmitted. Therefore, it is determined that the transmission of the data packet 420 is not complete. At this time, the data transmitting system 100 of the present disclosure will continue transmitting the data packet 420 to ensure its integrity. Furthermore, if it is determined that the transmission of all data packets is complete, the data transmitting system 100 of the present disclosure will enter the standby mode. In some embodiments, the data packet 420 can be a Receive-Side Coalescing (RSC) packet or a Large Segment Offload (LSO) packet.

In some embodiments, please refer to step 220, after the data transmitting system 100 of the present disclosure waits for the target time, the data transmitting system 100 determines whether the storage space corresponding to at least one data packet contains no data packet. If it is determined that the storage space corresponding to the at least one data packet no longer contains any data packets, the standby mode is executed. For example, after the data transmitting system 100 of the present disclosure waits for the target time, the data transmitting system 100 determines whether the storage space storing the data packets contains no data packet. If it is determined that the storage space contains no data packet, this indicates that there are no more packets to be transmitted, and the data transmitting system 100 of the present disclosure will directly enter the standby mode. In some embodiments, the storage space can be a First-In-First-Out (FIFO) buffer, a Baseboard Management Controller (BMC) buffer, or a MAC address buffer.

In some embodiments, please refer to step 220, after the data transmitting system 100 of the present disclosure waits for the target time, the data transmitting system 100 determines whether a storage space corresponding to a plurality of data packets contains no data packet. If it is determined that the storage space corresponding to the plurality of data packets still contains other data packets, a stop transmission command is generated. Subsequently, the target data packet of the plurality of data packets is segmented at the packet boundary according to the stop transmission command. Then, the target data packet is transmitted. For example, after the data transmitting system 100 of the present disclosure waits for the target time, the data transmitting system 100 determines whether a storage space storing the data packets contains no data packet. If it is determined that the storage space still contains other data packets, the data transmitting system 100 of the present disclosure generates a stop transmission command (Bulk Transfer End Transfer). Then, the target data packet is segmented at the packet boundary according to the stop transmission command to maintain the integrity of the target data. Subsequently, the data transmitting system 100 of the present disclosure transmits the target data packet.

In some embodiments, after the data transmitting system 100 of the present disclosure executes the standby mode, the data transmitting system 100 determines whether the target data packet meets the wake-up condition. If it is determined that the target data packet meets the wake-up condition, the data transmitting system 100 will switch from the standby mode to a normal mode, and the data transmitting system 100 transmits the target data packet. For example, if it is determined that the target data packet meets the wake-up condition, the data transmitting system 100 of the present disclosure can quickly wake up from the standby mode, and the data transmitting system 100 transmits the target data packet. In some embodiments, the data transmitting system 100 of the present disclosure can restore from the standby mode to a normal mode according to a wake-up signal. In some embodiments, the wake-up condition can be a remote wake-up, such as a Magic Packet wake-up, a pattern match wake-up, a packet filter wake-up, or other packet wake-ups. Additionally, the wake-up condition can be a system side wake-up, such as a user pressing a key on the keyboard or a button on the mouse.

It should be noted that the present disclosure is not limited to the embodiments as shown in FIG. 1 to FIG. 4, they are merely examples for illustrating the implements of the present disclosure, and the scope of the present disclosure shall be defined based on the claims as shown below. In view of the foregoing, it is intended that the present disclosure covers modifications and variations to the embodiments of the present disclosure, and modifications and variations to the embodiments of the present disclosure also fall within the scope of the following claims and their equivalents.

As described above, technical features of some embodiments of the present disclosure make an improvement to the prior art. The data transmitting method and the data transmitting system of the present disclosure can adjust the delay time for entering the standby mode to the target time to significantly reduce the waiting time. As a result, after the consumer selects the standby mode, the data transmitting system can quickly enter the standby mode, thereby enhancing the consumer experience.

It should be noted that people having ordinary skill in the art can selectively use some or all of the features of any embodiment in this specification or selectively use some or all of the features of multiple embodiments in this specification to implement the present invention as long as such implementation is practicable; in other words, the way to implement the present invention can be flexible based on the present disclosure.

The descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A data transmitting method, executed by a processor reading at least one command stored in a memory, comprising:
adjusting a delay time to a target time according to a standby signal;
after waiting for the target time, determining whether there is at least one data packet to decide whether to transmit the at least one data packet; and
executing a standby mode.

2. The data transmitting method of claim 1, wherein adjusting the delay time to the target time according to the standby signal comprises:
decreasing the delay time to the target time according to the standby signal.

3. The data transmitting method of claim 1, wherein the target time is less than the delay time.

4. The data transmitting method of claim 1, wherein the target time ranges from 1 microsecond to 5 milliseconds.

5. The data transmitting method of claim 1, wherein after waiting for the target time, determining whether there is the at least one data packet to decide whether to transmit the at least one data packet comprises:
after waiting for the target time, if there is the at least one data packet, determining whether a transmission of the at least one data packet is complete; and
if it is determined that the transmission of the at least one data packet is not complete, continuing transmitting the at least one data packet.

6. The data transmitting method of claim 5, wherein executing the standby mode comprises:
if it is determined that the transmission of the at least one data packet is complete, executing the standby mode.

7. The data transmitting method of claim 1, wherein after waiting for the target time, determining whether there is the at least one data packet to decide whether to transmit the at least one data packet comprises:
after waiting for the target time, determining whether a storage space corresponding to the at least one data packet contains no data packet;
wherein executing the standby mode comprises:
if it is determined that the storage space corresponding to the at least one data packet contains no data packet, executing the standby mode.

8. The data transmitting method of claim 1, wherein after waiting for the target time, determining whether there is the at least one data packet to decide whether to transmit the at least one data packet comprises:
after waiting for the target time, determining whether a storage space corresponding to a plurality of data packets contains no data packet;
if it is determined that the storage space corresponding to the plurality of data packets contains other data packet, generating a stop transmission command;
segmenting a target data packet of the plurality of data packets at a packet boundary according to the stop transmission command; and
transmitting the target data packet.

9. The data transmitting method of claim 1, further comprising:
after executing the standby mode, determining whether a target data packet meets a wake-up condition; and
if it is determined that the target data packet meets the wake-up condition, switching from the standby mode to a normal mode, and transmitting the target data packet.

10. The data transmitting method of claim 1, further comprising:
restoring the standby mode to a normal mode according to a wake-up signal.

11. A data transmitting system, comprising:
a memory, configured to store at least one command; and
a processor, configured to read the at least one command to execute following steps:
adjusting a delay time to a target time according to a standby signal;
after waiting for the target time, determining whether there is at least one data packet to decide whether to transmit the at least one data packet; and
executing a standby mode.

12. The data transmitting system of claim 11, wherein adjusting the delay time to the target time according to the standby signal which is executed by the processor comprises:
decreasing the delay time to the target time according to the standby signal.

13. The data transmitting system of claim 11, wherein the target time is less than the delay time.

14. The data transmitting system of claim 11, wherein the target time ranges from 1 microsecond to 5 milliseconds.

15. The data transmitting system of claim 11, wherein after waiting for the target time, determining whether there is the at least one data packet to decide whether to transmit the at least one data packet which is executed by the processor comprises:
after waiting for the target time, if there is the at least one data packet, determining whether a transmission of the at least one data packet is complete; and
if it is determined that the transmission of the at least one data packet is not complete, continuing transmitting the at least one data packet.

16. The data transmitting system of claim 15, wherein executing the standby mode which is executed by the processor comprises:
if it is determined that the transmission of the at least one data packet is complete, executing the standby mode.

17. The data transmitting system of claim 11, wherein after waiting for the target time, determining whether there is the at least one data packet to decide whether to transmit the at least one data packet which is executed by the processor comprises:
after waiting for the target time, determining whether a storage space corresponding to the at least one data packet contains no data packet;
wherein executing the standby mode which is executed by the processor comprises:
if it is determined that the storage space corresponding to the at least one data packet contains no data packet, executing the standby mode.

18. The data transmitting system of claim 11, wherein after waiting for the target time, determining whether there is the at least one data packet to decide whether to transmit the at least one data packet which is executed by the processor comprises:
after waiting for the target time, determining whether a storage space corresponding to a plurality of data packets contains no data packet;
if it is determined that the storage space corresponding to the plurality of data packets contains other data packet, generating a stop transmission command;
segmenting a target data packet of the plurality of data packets at a packet boundary according to the stop transmission command; and
transmitting the target data packet.

19. The data transmitting system of claim 11, wherein the processor further executes following steps:
after executing the standby mode, determining whether a target data packet meets a wake-up condition; and
if it is determined that the target data packet meets the wake-up condition, switching from the standby mode to a normal mode, and transmitting the target data packet.

20. The data transmitting system of claim 11, wherein the processor further executes following step:
restoring the standby mode to a normal mode according to a wake-up signal.
